(19) United States
(12) Patent Application Publication
(10) Pub. No.: US 2025/0378490 A1
(43) Pub. Date: Dec. 11, 2025

(54) RELATIVE CO-RELATION SECURED BOND INDEX MODELING

(71) Applicant: Wells Fargo Bank, N.A., San Francisco, CA (US)

(72) Inventors: Srinivasa Rao Aravala, Hyderabad (IN); Raman K. Mishra, Hyderabad (IN)

(21) Appl. No.: 18/734,850

(22) Filed: Jun. 5, 2024

(51) Int. Cl. G06Q 40/04

(52) U.S. Cl. CPC G06Q 40/04

(57) ABSTRACT

A computer system and method for identifying price outliers among bonds within a class of similarly situated bonds. The system comprises one or more processors and non-transitory computer-readable storage media, enabling the system to: identify a group of nearest neighbor bonds that share similar attributes using a k-nearest neighbor algorithm; assess the volatility of each bond within this group; create a filtered group by excluding bonds with volatilities above a predefined threshold; calculate correlation coefficients between each pair of bonds in the filtered group; and sort this group based on the correlation coefficients to select a predetermined number of bonds that form an index group. Additionally, the system computes a weighted average index price for the index group and determines the variance for each bond relative to this index price. This approach allows for the effective detection of price outliers, facilitating more informed investment decisions.

### BACKGROUND

The bond market is an important component of global finance, enabling governments, municipalities, and corporations to raise capital by issuing debt securities. However, traders and investors face significant challenges in accurately pricing these bonds. Traditional methods for evaluating bond prices often rely on historical data and basic statistical techniques that may not account for the nuanced differences between bonds that share similar traits such as yield, maturity, or ratings. This can lead to inefficiencies in pricing, misinformed investment decisions, and increased risk.

### SUMMARY

Embodiments of the disclosure are directed to identifying price outliers among bonds within a similarly situated class of bonds, including identifying a plurality of bonds sharing similar attributes through a k-nearest neighbor algorithm to establish a group of nearest neighbor bonds, identifying a volatility for each bond in the group of nearest neighbor bonds, creating a filtered group of nearest neighbor bonds by excluding bonds with volatilities exceeding a predefined threshold, calculating a correlation coefficient between each pair of bonds within the filtered group of nearest neighbor bonds, sorting the filtered group of nearest neighbor bonds based on the correlation coefficient of each bond, and selecting a predetermined number of bonds from the filtered group of nearest neighbor bonds to form an index group, computing a weighted average index price for the index group, and determining a variance for each bond within the index group in relation to the weighted average index price.

Embodiments also encompass a computer system for identifying price outliers among bonds within a similarly situated class of bonds. The computer system includes one or more processors and non-transitory computer-readable storage media. When executed by the processors, the instructions stored in the media enable the computer system to perform the following steps: identify a plurality of bonds sharing similar attributes through a k-nearest neighbor algorithm to establish a group of nearest neighbor bonds, assess volatility for each bond in the group of nearest neighbor bonds, create a filtered group of nearest neighbor bonds by excluding bonds with volatilities exceeding a predefined threshold, calculate a correlation coefficient between each pair of bonds within the filtered group, sort the filtered group based on the correlation coefficient, and select a predetermined number of bonds to form an index group, compute a weighted average index price for the index group, and determine a variance for each bond within the index group in relation to the weighted average index price.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a computer system for valuation of assets.

FIG. 2 shows an example server device of the computer system of FIG. 1.

FIG. 3 shows an example method of identifying price outliers among a class of similarly situated assets.

FIG. 4 shows example physical components of the server device of FIG. 2.

### DETAILED DESCRIPTION

This disclosure relates to valuation of assets, particularly in relation to a similarly situated class of assets.

For example, in one embodiment, the concept relates to identifying one or more bonds within a class of similarly situated bonds whose prices are substantially divergent, either above or below, from an average price of the class. While the specific embodiments detailed herein address bonds as the assets subject to valuation, the underlying principles and methodologies are applicable across an extensive range of financial securities. This includes, but is not limited to, equities, derivatives such as options and futures, mortgage-backed securities, municipal securities, and other financial instruments which may exhibit similar characteristics regarding market behavior and valuation methods.

A bond is a long term contract under which a borrower agrees to make payments of interest and principal on specific dates to the holders of the bond. Bonds are issued by corporations and government agencies that are looking for long-term debt capital. Bonds are typically represented by electronic data stored in secured computers.

Bonds can be grouped in several ways. One grouping is based on the issuer; the US treasury, corporations, state and local governments, and foreigners. Each bond differs with respect to risk and consequently its expected return.

For example, although treasury bonds issued by the federal government are considered low risk the price of these bonds decline when interest rates rise. Corporate bonds issued by business firms are additionally subjected to a credit risk, or risk of default should the Corporation become unable to repay the bond. Additionally, many corporate bonds have provisions that allow the issuer to pay them off early (sometimes referred to as a “call” feature), which can have an effect on the bonds price. Foreign bond prices can additionally fluctuate based on currency fluctuations or relative exchange rates between holding and issuing countries.

The par value is the stated value of the bond. The par value generally represents the amount of money the entity borrows and promises to repay on the maturity date. Bonds generally have a specified maturity date on which the par value must be repaid, as well as a series of interest or coupon payments due over the life of the bond. Typically at the time a bond is issued, a coupon payment is set at a level that will induce investors to buy the bond at or near its par value. When the annual coupon payment is divided by the par value, the result is the coupon interest rate. Some bonds can be fixed rate bonds with the coupon interest rate fixed for the life of the bond. Other bonds can be floating-rate bonds in which the coupon interest rate is adjustable based on an open market rate. Other types of bonds pay no coupons at all (sometimes referred to as zero coupon bonds), but are offered at a discount below their par value, and may provide capital appreciation rather than interest income.

The value of any financial assets—a stock, a bond, a lease, or even a physical asset such as an apartment building or piece of machinery—is the present value of the cash flows the asset is expected to produce. The cash flows for a typical coupon bearing bond include the interest payments during the bonds life plus the amount borrowed (generally the par value) when the bond matures. In the case of a floating bond rate, interest payments vary over time. For zero coupon bonds, there is no interest payments; so the only cash flow is the face amount when the bond matures. For bonds with fixed coupons, the present value (e.g., what the bond is worth on any given day) can be calculated according to the following formula:

$$Present Value = {\sum }_{t = 1}^{N} \frac{INT}{{( 1 + rd )}^{t}} + \frac{M}{{( 1 + rd )}^{N}}$$

where rd is the discount rate reflecting the market interest rate adjusted for the specific risk profile of the bond (note that unlike the coupon interest rate, the discount rate can change over the life of the bond); N is the number of years before the bond matures; INT is the coupon payment per period (interest paid to the bondholder); and M is the face value of the bond (the principal amount paid at maturity).

Thus, the cash flows for a bond include of an annuity of N years plus a lump sum payment at the end of year N. Normally, the coupon interest rate is set at the going rate in the market the day a bond is issued, causing the bond to sell at par initially. The coupon interest rate remains fixed after the bond is issued, but the market interest rate moves up and down based on a number of factors. Generally an increase in the discount rate causes the price of an outstanding bond to fall, whereas a decrease in the discount rate causes the bonds price to rise. The longer that a bond has until maturity, the more its price changes in response to a given change in its discount rate.

The discount rate, commonly referred to as the yield to maturity (YTM), is frequently used by financial publications and discussed by investors when considering rates of return. YTM is the internal rate of return expected on a bond if it is held until the maturity date, assuming that all coupon and principal payments are made as scheduled. YTM takes into account the bond's current market price, its nominal value, the coupon interest rate, and the time remaining until maturity, and is expressed as an annual rate. Factors such as market supply and demand, as well as broader macroeconomic conditions like economic growth and central bank monetary policy, can influence YTM, affecting its utility as a reliable indicator of bond performance.

Notably, the methodologies for calculating YTM vary, with differing emphasis on various contributing factors. For example, certain methodologies may prioritize the time value of money, while others may adjust for factors such as credit risk, market liquidity, or tax considerations, each affecting the computed YTM and, consequently, the perceived value and risk associated with a bond.

In some instances, YTM is determined based on the trade prices of bonds. Given that corporate bonds are predominantly traded in the over-the-counter (OTC) market, the trading prices provide a real-time foundation for YTM calculation. Specifically, when the trade price or present value of a bond is established, the aforementioned formula can be employed to derive the discount rate by solving for rd.

To promote transparency and regulatory compliance, the Financial Industry Regulatory Authority (FINRA) has implemented the Trade Reporting and Compliance Engine (TRACE). TRACE mandates the reporting of all secondary market transactions in eligible fixed income securities, serving as a mechanism for the dissemination of transactional data, including prices and volumes. Through TRACE, stakeholders gain access to essential market data that supports the analysis of market trends, bond valuation assessments, and accurate YTM calculations.

In the assessment of bond valuation, whether examining computed present values or actual trading prices, investors often consider the potential rate of return relative to alternative investments possessing comparable risk and duration characteristics. Despite the utility of knowing a bond's present value or discount rate, these metrics alone do not provide comprehensive insights into the bond's relative market pricing. Specifically, such data do not indicate whether a particular corporate bond is priced appropriately in relation to similarly situated corporate bonds, that is, whether the bond is overpriced or underpriced given its risk level and expected returns.

U.S. Treasuries provide a stable index against which the yields of other types of bonds, including corporate bonds, can be measured. However, while U.S. Treasuries (e.g., the 5-year treasury, etc.) offer a reliable baseline for general market conditions, their applicability in directly comparing with corporate bonds can be limited. Corporate bonds may be influenced by additional market dynamics and credit risks that do not affect U.S. Treasuries to the same extent. For instance, changes in the financial health of the issuing corporation, or shifts in the industrial sector's economic outlook, can significantly impact the performance and perceived risk of corporate bonds. Consequently, while U.S. Treasuries serve as a foundational benchmark for yield comparisons, they may not fully encapsulate the specific risk factors associated with individual corporate bonds.

The present disclosure addresses these challenges by leveraging advanced computational techniques and data integration to identify price outliers among bonds classified within a similarly situated class. In some embodiments, the concept employs a k-nearest neighbor (KNN) algorithm to establish a group of nearest neighbor bonds by identifying multiple bonds that share common attributes such as coupon, yield, ratings, maturity, sector, industry, and embedded options, which allows for a granular and nuanced analysis of bonds, ensuring that only those with similar financial and market characteristics are compared.

Upon grouping, the concept involves assessing the volatility of each bond within the group, for example, by calculating the standard deviation of bond sales prices over a predetermined time period. In embodiments, volatility data can be sourced from third-party trade reporting and compliance engines, enhancing the accuracy and reliability of volatility assessments. Bonds exhibiting volatilities that exceed a predefined threshold can be excluded from the group, thereby filtering out bonds that might skew the analysis due to excessive price fluctuations.

Additionally, the concept can involve calculating a correlation coefficient for each pair of bonds within the filtered group. This calculation can be based on determining the statistical association between the sales prices of the bonds over a specified period. By recording these transactions on a blockchain, the concept can ensure that the data remains immutable and transparent, fostering trust and integrity in the computational process. Following this, the bonds can be sorted based on their correlation coefficients, and a predetermined number of bonds with the highest correlation are selected to form an index group.

For the selected index group, a weighted average index price can be computed, taking into account the corresponding outstanding amount of each bond. This price can serve as a benchmark for evaluating the variance or spread of each bond within the index group in relation to the computed index price. Unlike U.S. Treasuries, which provide a general baseline for market conditions, the weighted average index price more closely aligns with the attributes of the bonds under consideration. By reflecting the specific characteristics and market dynamics of the bonds in the index group, the weighted average index offers a more accurate and relevant alternative to U.S. Treasuries for benchmarking purposes, thereby better encapsulating the unique risk factors associated with individual corporate bonds. Variance data, which provides insight into the price behavior of each bond relative to the group average, can also be recorded on the blockchain, ensuring secure and accurate tracking of price deviations.

The concept addresses the limitations encountered in conventional bond valuation techniques, which often do not account for the nuanced differences among bonds with similar characteristics. By integrating precise computational algorithms with secure data handling and analysis methods, the invention provides a robust framework for identifying bond price outliers, enhancing investment strategies, and improving the overall efficiency of financial markets.

The disclosed concept involves leveraging advanced data processing techniques to analyze and identify variances in asset prices within an index group, thereby transforming raw data from financial reporting systems like TRACE into actionable intelligence. In some embodiments, the concept is designed to process this data in real-time, which enables the immediate detection of outliers in bond prices relative to a weighted average index price. For example, by setting predefined thresholds for variances, the concept can automatically generate notifications or alerts whenever these thresholds are exceeded, ensuring that the system's users can react promptly to significant market movements.

In embodiments, the concept can identify bonds with similar attributes to form a group of nearest neighbor bonds. The concept then applies a series of filters based on computed volatilities and correlation coefficients to refine this group further, resulting in a curated dataset of bonds that are most representative of current market conditions. This selective filtering process ensures that only relevant and similarly situated assets are analyzed for variance against the weighted average index price. Moreover, the integration of these specific processing steps represents a practical application of the underlying algorithms, converting abstract financial data into a structured and valuable tool for market analysis.

The disclosed concept is intrinsically tied to advanced computer technology and specifically addresses challenges that emerge within the domain of computer networks, particularly those related to the real-time acquisition and processing of financial data from systems such as TRACE. By leveraging a sophisticated arrangement of computational resources, the system is configured to perform high-speed data ingestion and analysis, a necessity for maintaining the integrity and relevance of financial assessments in volatile markets. This capability is critical for enabling the system to identify and react to rapid changes in asset prices, which is a problem specifically arising from the dynamic nature of financial data streams in computer networks. The real-time processing of data from financial reporting systems for valuation analysis represents a practical application of technology that transcends conventional data processing by mitigating latency and synchronization challenges inherent in live financial data feeds.

Furthermore, the disclosed concept innovates beyond mere data aggregation and display by implementing a novel method for filtering, arranging, and analyzing financial data. This includes a unique algorithmic approach to dynamically selecting and refining groups of nearest neighbor bonds based on multi-dimensional attributes like volatility and correlation coefficients. These attributes are computed through algorithms tailored to integrate real-time data inputs, enhancing the system's ability to adapt to current market conditions. By curating a dataset of bonds that reflect the most representative market conditions and using this dataset to perform variance analysis against a weighted average index price, the system organizes financial data in a way that significantly improves the utility and accuracy of market predictions. This method of data handling and analysis ensures that the financial data is not only collected and displayed but is also transformed into actionable intelligence through a non-generic and non-conventional arrangement of computing components.

The architecture and functionality of the system embody a non-conventional and non-generic arrangement of components, which are tailored to address specific computational inefficiencies found in standard financial data analysis tools. This includes the integration of a specialized data processing module that interacts directly with real-time data feeds to reduce delays in data availability and a correlation analysis module that employs advanced mathematical models to determine the interdependencies between assets quickly. These components are configured in a manner that optimizes computational efficiency and accuracy, making the system significantly more capable than traditional data processing applications in handling the complexities of financial market analytics. Such innovations underscore the patent eligibility of the disclosed concept, highlighting its rootedness in overcoming specific technological challenges associated with real-time financial data processing and analysis in computer networks.

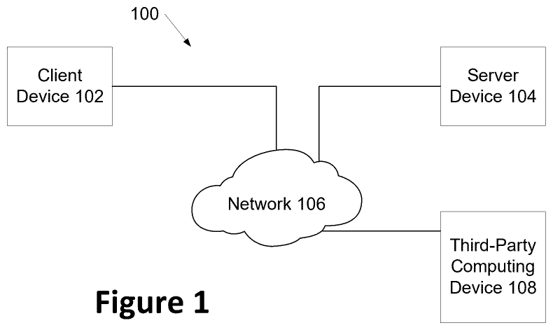

FIG. 1 illustrates a schematic of a computer system 100 designed for identifying price outliers among assets within a similarly situated class of assets. As depicted in FIG. 1, the computer system 100 encompasses a computing environment comprised of one or more client devices 102 connected to a server device 104 via a network 106. The one or more client devices 102 can be computing devices equipped with processors and memory, capable of initiating various tasks related to asset valuation. These client devices 102 can encompass a variety of computing devices such as desktop computers, laptops, integrated development environment systems, or other hardware capable of interfacing with the components of the network 106.

The server device 104, which may be a single server or a collection of servers within a server farm, possesses computing resources including processors and data storage repositories, enabling the one or more client devices 102 to engage in complex tasks involving the receipt and processing of data from a variety of sources. The analytical capabilities of the server device 104 are directed at analyzing data to facilitate asset valuation and price outlier identification processes.

Although depicted as physically distinct devices, the one or more client devices 102 and the server device 104 can share resources such as processors and databases, enabling a unified approach to analyzing interactions and formulating response strategies. In certain embodiments, the server device 104 may also incorporate resources from a third-party vendor or contracting partner, depicted as a third-party computing device 108. These resources from the third-party computing device 108 can include one or more generative pre-trained transformers or other algorithms or features to improve the functionality of the modules described herein.

The network 106 serves as the underlying communication framework, facilitating data exchange and interaction between the one or more client devices 102 and the server device 104. Additionally, the network 106 enables the reliable and secure transmission of data and commands within computer system 100, supporting real-time analysis based on the most current reported asset prices and other pertinent economic indicators from the third-party computing device 108.

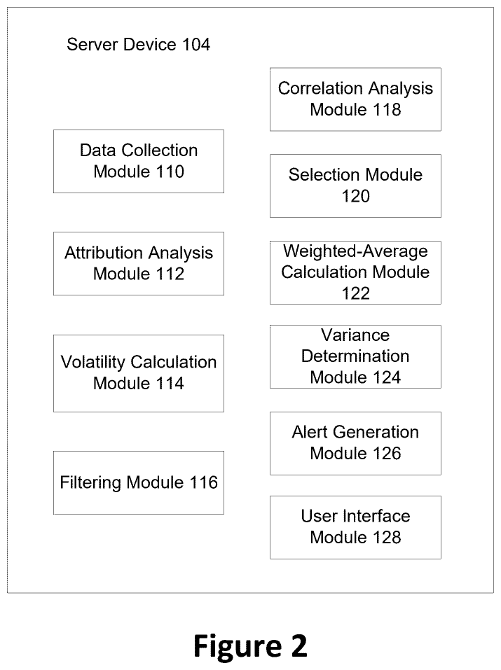

As shown in FIG. 2, the server device 104 can comprise one or more modules, with each module configured as a specialized component adapted to perform specific computational processing tasks within the computer system 100. In certain embodiments, the server device 104 can incorporate the following modules: data collection module 110, attribution analysis module 112, volatility calculation module 114, filtering module 116, correlation analysis module 118, sorting and selection module 120, weighted-average calculation module 122, variance determination module 124, alert generation module 126, and user interface module 128. Together, these modules constitute a comprehensive sub-system within the server device 104, facilitating asset valuation, particularly in relation to a group of similarly situated assets.

The data collection module 110 is configured to acquire and consolidate data relevant to bonds and other financial assets. In some embodiments, the data collection module 110 is capable of interfacing with one or more resources from the third-party computing device 108, including financial databases, to ensure an inflow of comprehensive financial information. These sources can include real-time market data feeds and third-party trade reporting systems, such as the TRACE. Additionally, the data collection module 110 can query one or more financial databases for a wide array of financial metrics, such as an established coupon rate, yield to maturity, current yield, duration, credit risk, price volatility, interest rate risk, market conditions, inflation expectations, liquidity, tax considerations, call provisions, currency risk, and other economic factors. This functionality allows for the integration and retrieval of up-to-date financial data, including prices, quantities of bonds traded, timestamps, and specifics of each transaction, thus providing a granular view of market activities.

Furthermore, the data collection module 110 is configured to process this market data in real-time, maintaining the currency of information to accurately reflect the latest market conditions. The data collection module 110 can additionally include one or more data validation algorithms to verify the accuracy and reliability of the data collected.

Data, whether generated internally or obtained from the third-party computing device 108, can be converted to a blockchain format before storage. The blockchain conversion can involve creating a digital ledger of transactions distributed across the network, thus ensuring data immutability, transparency, and security.

The attribution analysis module 112 is configured to identify bonds that share similar attributes such as yield, maturity, ratings, and sector. In some embodiments, the attribution analysis module 112 employs a KNN algorithm to group bonds based on these shared characteristics, facilitating the comparison and analysis of bonds within similarly situated classes.

The KNN algorithm utilized by the attribution analysis module 112 can operate by measuring the similarity between different bonds based on the specified attributes. The first step in KNN is to calculate a distance between the query point (the data point whose class or value needs to be predicted) and all the points in the training dataset.

This distance often measured in Euclidean space, can be computed according to the formula:

$$d ( p , q ) = ( \sqrt{{( q 1 - p 1 )}^{2} + {( q 2 - p 2 )}^{2} + ⋯ + {( qn - pn )}^{2}}$$

where p1−n represents attributes of a first bond, q1−n represent the same attributes of a second bond, and d(p,q) represents a composite distance between the attributes of the first and second bonds in Euclidean n-space. This distance, can provide a quantitative basis for determining which bonds are most similar to a given bond.

Specifically, the KNN algorithm can be programmed to select the ‘k’ closest bonds to a target bond, where ‘k’ is a predefined number representing the number of neighbors to identify. These bonds are then considered nearest neighbors due to their similar attribute values.

For instance, if the attribution analysis module 112 is set to identify one hundred nearest neighbors for a particular bond with specific characteristics in terms of yield, maturity, ratings, and sector, the KNN algorithm will scan through the dataset to find the bonds that are closest to the target bond in terms of these attributes. The distance calculation may incorporate a number of factors, possibly giving different weights to each based on their importance or relevance to the analysis being conducted. This approach enables the attribution analysis module 112 to create clusters or groups of bonds that are expected to behave similarly under market conditions, providing a framework for further analysis such as outlier detection or risk assessment.

The volatility calculation module 114 is configured to determine a volatility of each bond within a group of nearest neighbor bonds identified by the attribution analysis module 112. In embodiments, the volatility calculation module 114 can calculate the volatility by determining the standard deviations of bond prices over a specified time period. This statistical measure can provide an assessment of the price fluctuations and stability of each bond for understanding their risk profiles.

The computation of volatility typically involves analyzing historical price data, which the volatility calculation module 114 can retrieve from the data collection module 110. The historical data can include daily closing prices of bonds over the defined period, allowing the volatility calculation module 114 to compute the mean price and subsequently, the deviations of daily prices from this mean. In embodiments, the deviations can be squared, summed, and averaged to derive the variance, with the square root of this variance representing the standard deviation, or volatility.

In some embodiments, the volatility calculation module 114 can access volatility data directly from external sources, which can include pulling computed volatility figures for specific bonds from publicly available databases, where such data may be provided by financial market data services. External volatility measures which may be calculated using similar statistical methods and can be directly integrated into the volatility calculation process without the need for internal computation.

The filtering module 116 is configured to refine a selection of bonds for inclusion in the plurality of bonds sharing similar attributes by applying predefined thresholds to exclude those bonds with volatilities that exceed certain specified limits.

In some embodiments, the filtering module 116 can compare the volatility of each bond, as computed by the volatility calculation module 114, against established volatility thresholds. These thresholds can be set based on the risk tolerance levels pertinent to the analysis objective or the investor profile. Bonds that exhibit volatilities higher than these thresholds may be deemed unsuitable for inclusion within an index group and are systematically excluded from the group of nearest neighbor bonds, ensuring that subsequent steps in the analysis process are based on data from more stable securities.

For example, consider a scenario where the predefined volatility threshold is set at 5% per annum. If a particular corporate bond, say Bond A, shows a computed annual volatility of 7% due to specific risks such as heightened sensitivity to market interest rate changes or credit rating downgrades, this bond would exceed the threshold set by the filtering module 116. As a result, Bond A would be excluded from further analysis. This exclusion helps mitigate potential biases or distortions in the analysis results that might arise from the inclusion of bonds with unacceptably high volatility levels.

The correlation analysis module 118 is configured to compute the correlation coefficients between each pair of bonds within the filtered group, as refined by the filtering module 116. For example, in some embodiments, the correlation analysis module 118 facilitates a quantitative assessment of the relationships between the price movements of different bonds for identifying underlying similar patterns or interdependencies that may exist among the selected securities.

Correlation coefficients are calculated to measure the degree to which the prices of two bonds move in relation to each other. This statistical metric ranges from −1 to +1, where a value of +1 indicates a perfect positive correlation (prices of both bonds move in the same direction to the same extent), a value of −1 signifies a perfect negative correlation (prices of the bonds move in opposite directions to the same extent), and a value of 0 denotes no correlation (the movements of one bond's price do not predict the movements of the other bond's price).

The process implemented by the correlation analysis module 118 involves the statistical computation of the covariance between the price series of each pair of bonds, normalized by the product of their standard deviations. This calculation may use historical price data provided by the data collection module 110 to reflect comprehensive and up-to-date market dynamics.

For example, if two bonds from the filtered group show a high positive correlation coefficient, such as 0.85, it indicates that these bonds tend to move in tandem, suggesting that similar factors might be influencing their price behaviors. Conversely, a low or negative correlation might suggest that the bonds react differently to market conditions, and thus could serve different purposes in portfolio diversification.

The sorting and selection module 120 is configured to organize the bonds that have passed through the filtering module 116 based on their calculated correlation coefficients, as determined by the correlation analysis module 118. In one embodiment, the sorting and selection module 120 sorts the bonds within the filtered group in descending order of their correlation coefficients to prioritize those bonds that exhibit the strongest relationships with each other in terms of price movements.

Following the sorting process, the sorting and selection module 120 can select a predetermined number of bonds from the sorted list to form an index group, with the aim to include bonds that best represent the typical market behavior of the class. The predetermined number is set based on the specific requirements of the analysis or the intended use of the index group, such as for benchmarking or portfolio management.

For instance, if the system is configured to select the top ten bonds with the highest correlation coefficients from a sorted list of fifty bonds, the sorting and selection module 120 will identify and isolate these ten bonds. The selected bonds are those that not only share similar attributes but also behave in a closely correlated manner in the marketplace, indicating that they are influenced by similar economic, sectoral, or market factors. By focusing on bonds with high correlation coefficients, the sorting and selection module 120 helps to ensure that the index group is homogeneous and accurately reflective of the broader bond class it represents.

The weighted-average calculation module 122 is configured to compute the weighted average index price for the index group of bonds, as formulated by the sorting and selection module 120. In some embodiments, the weighted-average calculation module 122 integrates one or more financial metrics, such as the outstanding amount and the yield of each bond within the index group, to calculate a composite index price that reflects the collective value and performance characteristics of the group.

In some embodiments, the computation process involves multiplying the yield of each bond by its corresponding outstanding amount or some other variable, which represents the total market value of each bond in circulation. These products are then summed across all bonds in the index group. The aggregate of these summed products is subsequently divided by the total of the outstanding amounts for all the bonds in the group. This division normalizes the aggregated values, resulting in a single price figure that serves as the weighted average index price.

This weighted average index price can serve as a benchmark within the financial analysis and investment processes, providing a standard against which the prices of individual bonds, either within the index group or external to it, can be compared. For example, if a specific bond's price significantly deviates from this weighted average, it might be identified as an outlier, prompting further analysis or investment decisions.

The variance determination module 124 is configured to calculate the variance of each bond within the index group relative to the computed weighted average index price, as established by the weighted-average calculation module 122. In some embodiments, the variance determination module 124 quantifies the degree to which the price of each individual bond differs from the benchmark average price, providing a metric of deviation to provide a more comprehensive financial analysis.

The operation of the variance determination module 124 can involve subtracting the weighted average index price from the price of each bond in the index group and squaring the result to eliminate negative values. The squared deviations can then be averaged to compute the variance for each bond. This calculation not only measures the dispersion of bond prices around the average but also highlights how individual bonds perform in comparison to the collective behavior of the group.

By identifying the variance for each bond, the variance determination module 124 plays a role in identifying outliers within the index group. Bonds whose variances exceed certain predefined thresholds may be identified for further analysis. Such outliers might represent exceptional risk or opportunity, diverging significantly from typical market behavior as represented by the index group.

The alert generation module 126 is configured to generate notifications or alerts when the variance of any bond within the index group exceeds predetermined threshold levels. In some embodiments, the alert generation module 126 is configured to interface with the variance determination module 124, receiving real-time data on the variance calculations for each bond. Upon detecting a variance that crosses the set threshold, the alert generation module 126 initiates an alert process.

The alert generation module 126 can be programmed to promptly notify system users or relevant stakeholders, facilitating an immediate response to significant deviations in bond prices relative to the group average, thereby enabling swift action to capitalize on opportunities or mitigate potential risks associated with market volatility.

Furthermore, the alerts generated by this alert generation module 126 can be designed to provide detailed information, including the identity of the bond, the specific variance measured, and a comparison to the predefined threshold to ensure that users receive comprehensive data to make informed decisions rapidly.

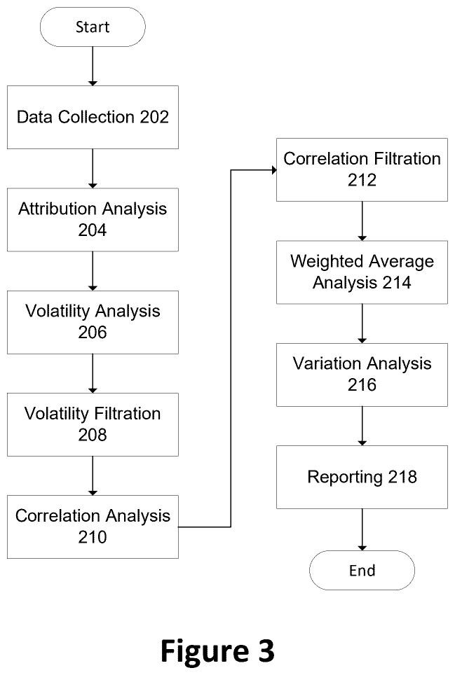

Referring to FIG. 3, an example method 200 is shown for identifying price outliers among assets within a similarly situated class of assets. The method 200 comprises a sequence of steps for collecting and processing transaction data, and in some embodiments can be implemented by the computer system 100. For example, the server device 104 can be configured to interact with the client device 102 and the third-party computing device 108 through the network 106 to facilitate the execution of the steps outlined in method 200.

At step 202, the method 200 can begin with collection of financial data pertinent to bond valuation, which in some embodiments can be facilitated through the data collection module 110. In practice, step 202 can involve retrieval of actual bond trade prices from third-party trade reporting and compliance engines or other databases to provide information about the executed trades in the bond market.

Additionally, step 202 can include querying one or more resources of the third-party computing device 108, which can contain a wide range of financial metrics relevant to analyzing bond characteristics. For example, step 202 can involve queries to gather financial metrics, including an established coupon rate for a given bond, its yield to maturity, current yield, duration, credit risk, price volatility, interest rate risk, market conditions, inflation expectations, liquidity, tax considerations, call provisions, currency risk, and other economic factors.

The interaction between the data collection module 110 and resources the third-party computing device 108 can be facilitated via the network 106 to send queries and receive responses.

In some embodiments, step 202 further includes storing the collected data in a blockchain format, which can involve specific procedural steps to ensure the data is securely recorded and immutable. In some embodiments of, the process commences with the collection of transaction data, such as time-stamped trade data or actual sales prices for bonds on the open market.

Once collected, the data undergoes a conversion process where the data can be encapsulated into a block, with each block containing a timestamp and transaction data, along with a cryptographic hash of the previous block, linking the blocks together in a chronological and secure manner. This linkage ensures that any alteration of the information in a preceding block would require alterations in all subsequent blocks, thereby securing the integrity of the entire chain.

Subsequently, the new block is broadcast to all network nodes in the blockchain network for validation. The nodes use consensus algorithms to agree on the validity of the blocks. Upon validation, the block is added to the existing blockchain, providing a permanent and tamper-evident record of the transaction data. Thereafter, the time stamp to trade the data or actual sales prices can serve as a secure foundation for further analysis, and can be accessed by authorized entities within the computer system 100 to ensure transparency and accountability in bond valuation processes.

Continuing to step 204, the method 200 can proceed with attribution analysis, for example by the attribution analysis module 112. Step 204 can involve employing a KNN algorithm to identify a plurality of bonds that share similar attributes, thereby establishing a group of nearest neighbor bonds. The KNN algorithm can evaluate attributes including coupon rate, yield, ratings, maturity, sector, industry, and default risks associated with each bond to generally group the bonds according to their relationships to one another.

For instance, in the application of the KNN algorithm for reviewing corporate bonds, the process can involve measuring the similarity between different bonds based on specified attributes such as yield and maturity, which are particularly relevant for assessing the bonds' investment profile. Suppose a target bond has a yield of 5% and a maturity of 10 years. The KNN algorithm operates by calculating the distance between the attribute vectors of the bonds, typically measured in Euclidean space, to provide a quantitative basis for determining which bonds are most similar to the target bond.

The algorithm can be programmed to select the ‘k’ closest bonds to a target bond, where ‘k’ is a predefined number representing the number of neighbors to identify. In this example, if ‘k’ is set to identify one hundred nearest neighbors (k=100) for the target bond, the KNN algorithm will scan through the dataset to find one hundred bonds that are closest to the target bond in terms of these attributes. The distance calculation may incorporate a number of factors, possibly giving different weights to each based on their importance or relevance to the analysis being conducted. These bonds are then considered nearest neighbors due to their similar attribute values, effectively grouping those that exhibit similar financial and market characteristics for further analysis.

As part of step 204, a sensitivity of the KNN algorithm can be adjusted for evaluating each attribute, thereby enabling the determination a degree of similarity required between bonds to be considered neighbors. Sensitivity settings adjust how stringently bonds are matched based on their attributes, allowing for fine-tuning of the bond selection process according to specific analytical needs.

Step 206 pertains to the volatility analysis, which is conducted to ascertain the volatility of each bond within the group of nearest neighbor bonds. In some embodiments, the volatility analysis is performed by the volatility calculation module 114, which executes several sub-steps to measure the volatility effectively.

Firstly, identifying the volatility involves calculating the standard deviation of bond sales prices over a predetermined time period. This calculation provides a statistical measure of the price fluctuation or volatility of each bond, indicating the degree of variation from the average price during the specified period. The bond sales prices for this calculation can be sourced from a third-party trade reporting and compliance engine, which can be compiled to create a time sequence of price data, reflecting the historical price movements of each bond.

Additionally, the volatility analysis of step 206 may involve evaluation of the Beta of each bond. Beta, a statistical measure, is used to determine the sensitivity of a bond's price relative to broader market movements. Beta quantifies how much a bond's price is expected to change in response to a given change in the market. A Beta value greater than one indicates that the bond's price is typically more volatile than the overall market, suggesting higher risk and potentially higher returns. Conversely, a Beta value less than one signifies that the bond's price movements are less volatile compared to the market, implying lower risk. Incorporating Beta into traditional volatility analyses based on actual trade prices can enrich the assessment of a bond's volatility by introducing a measure of sensitivity to broader market movements.

In certain embodiments, this time sequence of price data can optionally be stored in blockchain, enhancing the security and integrity of the data by providing a tamper-proof and immutable record. The use of blockchain ensures that the historical price data utilized in the volatility calculations is preserved in a verifiable and unalterable format, which is important for maintaining data accuracy and reliability.

Step 208 pertains to the process of filtering for volatility, which involves creating a filtered group of nearest neighbor bonds by systematically excluding those bonds whose volatilities exceed a predefined threshold. Step 208 executed to ensure that the bonds considered in further analyses maintain volatility levels within acceptable risk parameters. In some embodiments, the execution of step 208 can be performed by the filtering module 116.

In practice, once a group of nearest neighbor bonds is identified through the KNN algorithm based on shared attributes such as yield, maturity, ratings, and sector, the system then evaluates the volatility of each identified bond. The predefined threshold for acceptable volatility might be set based on historical volatility norms for similar bonds or tailored risk tolerance levels. For example, if the threshold is set at a volatility (standard deviation) of 5% annually, the filtering module 116 can exclude any bond among the identified bonds whose volatility surpasses this value, resulting in a filtered group with fewer than the original number of bonds, comprising only those bonds whose volatility metrics fall within the defined acceptable limits.

Step 208 of excluding bonds with excessive volatility ensures that the remaining group is more stable and predictable. The outcome of this step effectively streamlines the group for subsequent analytical processes, such as correlation analysis and outlier detection, focusing on those bonds that meet the established criteria for stability and risk.

Step 210 involves conducting a correlation analysis for understanding the relationships between the prices of different bonds within the filtered group of nearest neighbor bonds. Step 210 can be carried out by calculating the correlation coefficient between each pair of bonds. In some embodiments, execution of step 210 can be performed by the correlation analysis module 118.

The correlation coefficient between a pair of bonds can be calculated to determine the degree of statistical association between their sales prices over a specified period of time. This coefficient typically ranges from −1 to +1. A correlation coefficient of +1 indicates a perfect positive correlation, meaning that the prices of the two bonds move in the same direction to the same degree. Conversely, a coefficient of −1 signifies a perfect negative correlation, where the prices of the bonds move in opposite directions. A coefficient of 0 indicates no linear relationship between the bond prices.

To calculate the correlation coefficient, the correlation analysis module 118 can first compute the mean of the sales prices for each bond over the specified period. Subsequently, it can determine the deviations of individual sales prices from their respective means for each bond. These deviations can then be multiplied for corresponding prices of the two bonds, and the results can be summed. This sum can be divided by the product of the standard deviations of the sales prices for each bond, multiplied by the number of price observations. This calculated correlation coefficient can aid in assessing how closely the movements in prices of the two bonds are related, providing insights into their potential co-dependencies and how they might be expected to react under similar market conditions.

Step 212 involves filtering the group of nearest neighbor bonds based on their calculated correlation coefficients and selecting a predetermined number of bonds from this filtered group to form an index group. Step 212 can be executed to identify bonds that exhibit similar behavioral patterns in terms of price movements, thereby facilitating the creation of an index group that represents typical market behavior of the class. In some embodiments, step 212 can be carried out by a dedicated filtering and selection mechanism, such as the selection module 120.

During step 212, the bonds within the previously established filtered group of nearest neighbor bonds, already screened for acceptable levels of volatility, are further analyzed based on their correlation coefficients. Each bond's correlation coefficient is assessed to determine how closely the bond's price movements correlate with those of other bonds in the group. Bonds that do not meet a specified correlation threshold are excluded from further consideration, ensuring that only those bonds with strong mutual correlations are retained.

For example, continuing with the specific example of the filtered list of corporate bonds, suppose the selection module 120 is set to select the top fifty bonds based on their correlation coefficients from a filtered group that initially contained seventy-five corporate bonds after the volatility filtering. The bonds are ranked according to their correlation coefficients, and only the top fifty bonds with the highest coefficients are chosen to form the index group. This index group comprises bonds that not only share similar attributes and maintain volatility within defined thresholds but also move similarly in the market, providing a representative view of typical behaviors within this specific class of corporate bonds. Step 212 enhances the precision of the bond groupings by focusing on a subgroup of bonds whose price movements are consistently aligned with each other.

Step 214 involves computing a weighted average index price for the index group, a process that aggregates the price data of the selected bonds to establish a benchmark price for the group. In some embodiments, step 214 can be performed by the weighted-average calculation module 122.

In step 214, the weighted average index price can be computed by considering the corresponding outstanding amount for each bond within the index group. This can involve multiplying the price of each bond by its outstanding amount, thereby giving greater weight to bonds with larger outstanding amounts, as these represent a more significant portion of the market. The sum of these weighted prices can then be divided by the total of the outstanding amounts for all the bonds in the index group, resulting in the weighted average index price. Alternatively, other weighting factors can be applied to each bond to create a more balanced weighted average index.

The weighted average index price can aid in identifying trends in price fluctuations within the similarly situated class of bonds. The weighted average index price reflects the general pricing trend that bonds in the index group are expected to follow, based on their combined market characteristics and behaviors. Typically, it is anticipated that the trade price of bonds falling within the similarly situated class would generally align with the trend established by the weighted average index. This alignment suggests that the weighted average index price provides a benchmark for assessing whether individual bond prices are behaving typically or deviating from expected patterns.

Step 216 involves computing the variance for each bond within the index group in relation to the weighted average index price, for analyzing the deviation of individual bond prices from the established benchmark price. In some embodiments, step 216 can be facilitated by the variance determination module 124, which is tasked with calculating and assessing the variance of each bond's price as compared to the weighted average index price computed in step 214.

In step 216, the variance can be computed by determining the difference between the price of each bond and the weighted average index price, squaring this difference to negate negative values, and averaging these squared differences across the index group. This variance calculation can provide a quantitative measure of how much each bond's price deviates from the average, offering insights into the price stability and conformity of each bond within the group.

In some embodiments, the calculated variance for each bond within the index group can be recorded in a blockchain. The recorded variance data in the blockchain can be utilized by other system components, such as the alert generation module 126 or the user interface module 128.

Step 218 involves the reporting of results from the data collection and analysis processes to users, for example via a user interface, including variance data and price deviations, to enable informed decision-making. In embodiments, the computed variance data can trigger alerts or notifications through the user interface when a bond's variance exceeds a predetermined threshold. Such alerts can be indicative of significant deviations in bond prices that may warrant attention from users, potentially highlighting opportune moments for strategic investment actions such as buying or selling bonds.

Moreover, the data can be presented to highlight deviations in actual bond trade prices relative to the weighted average index price to assist users in identifying bonds that may be trading below or above the expected price, thereby suggesting potentially ideal times to purchase or sell specific bonds based on their current market valuation compared to the indexed group average.

In some embodiments, the results can be reported to users based on their specific interests or holdings. For example, for users who hold particular bonds, the results can be tailored to provide detailed insights into how those bonds are performing relative to the market. For users seeking to make new investments, the results can be customized based on a request or query for bonds or other assets that meet specific criteria for purchase. This personalized reporting enhances the utility of the user interface, making it a powerful tool for both routine portfolio management and strategic investment planning.

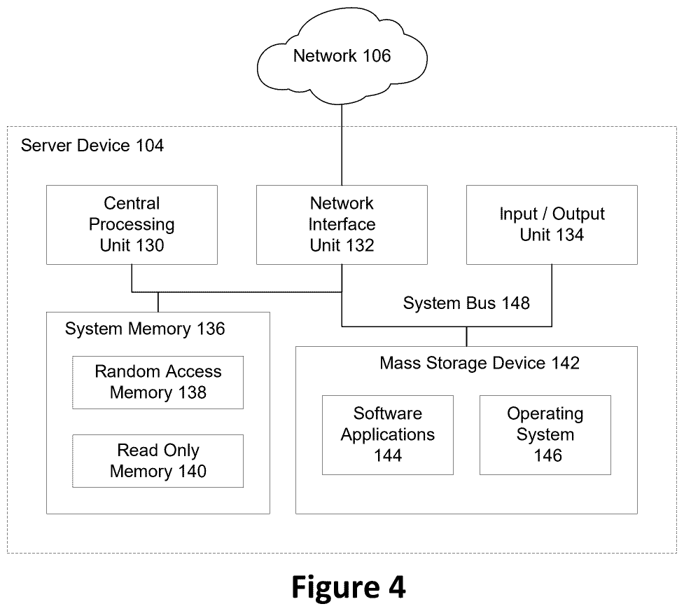

As illustrated in the embodiment of FIG. 4, the example server device 104, which provides the functionality described herein, can include at least one central processing unit (“CPU”) 130, a system memory 136, and a system bus 148 that couples the system memory 136 to the CPU 130. The system memory 136 includes a random access memory (“RAM”) 310 and a read-only memory (“ROM”) 140. A basic input/output system containing the basic routines that help transfer information between elements within the computer system 100, such as during startup, is stored in the ROM 140. The computer system 100 further includes a mass storage device 142. The mass storage device 142 can store software instructions and data. A central processing unit, system memory, and mass storage device similar to that shown can also be included in the other computing devices disclosed herein.

The mass storage device 142 is connected to the CPU 130 through a mass storage controller (not shown) connected to the system bus 148. The mass storage device 142 and its associated computer-readable data storage media provide non-volatile, non-transitory storage for the computer system 100. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 104.

According to various embodiments of the invention, the computer system 100 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server device 104 may connect to network 106 through a network interface unit 132 connected to the system bus 148. It should be appreciated that the network interface unit 132 may also be utilized to connect to other types of networks and remote computing systems. The server device 104 also includes an input/output controller 134 for receiving and processing input from a number of other devices, including a touch user interface display screen or another type of input device. Similarly, the input/output controller 134 may provide output to a touch user interface display screen or other output devices.

As mentioned briefly above, the mass storage device 142 and the RAM 138 of the server device 104 can store software instructions and data. The software instructions include an operating system 146 suitable for controlling the operation of the server device 104. The mass storage device 142 and/or the RAM 138 also store software instructions and applications 144, that when executed by the CPU 130, cause the server device 104 to provide the functionality of the computer system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for identifying price outliers among bonds within a similarly situated class, comprising:
identifying a plurality of bonds sharing similar attributes through a k-nearest neighbor algorithm to establish a group of nearest neighbor bonds;
identifying a volatility for one or more of the plurality of bonds in the group of nearest neighbor bonds;
creating a filtered group of nearest neighbor bonds by excluding those bonds with volatilities exceeding a predefined threshold;
calculating a correlation coefficient between pairs of the plurality of bonds within the filtered group of nearest neighbor bonds;
sorting the filtered group of nearest neighbor bonds based on the correlation coefficient of the pairs of bonds;
selecting a predetermined number of bonds from the filtered group of nearest neighbor bonds to form an index group;
computing a weighted average index price for the index group; and
determining a variance for the predetermined number of bonds within the index group in relation to the weighted average index price.

2. The method of claim 1, wherein the k-nearest neighbor algorithm evaluates attributes including coupon, yield, ratings, maturity, sector, industry, and embedded options.

3. The method of claim 2, further comprising establishing a sensitivity for the k-nearest neighbor algorithm in an evaluation of each attribute.

4. The method of claim 1, wherein identifying the volatility includes calculating a standard deviation of bond sales prices over a predetermined time period.

5. The method of claim 4, wherein the bond sales prices are received from a third-party trade reporting and compliance engine.

6. The method of claim 1, wherein identifying the volatility considers a beta of one or more of the plurality of bonds.

7. The method of claim 1, wherein calculating the correlation coefficient between the pairs of bonds within the filtered group of nearest neighbor bonds is performed by determining a degree of statistical association between bond sales prices over a specified period of time.

8. The method of claim 7, wherein the bond sales prices for the pairs of bonds within the filtered group of nearest neighbor bonds are received from a third-party trade reporting and compliance engine, and recorded in blockchain.

9. The method of claim 1, wherein the weighted average index price considers a corresponding outstanding amount for each bond of the index group.

10. The method of claim 1, wherein the variance for each bond within the index group in relation to the weighted average index price is recorded in blockchain.

11. A computer system for identifying price outliers among bonds within a similarly situated class, comprising:
one or more processors; and
non-transitory computer-readable storage media encoding instructions which, when executed by the one or more processors, cause the computer system to:
identify a plurality of bonds sharing similar attributes through a k-nearest neighbor algorithm to establish a group of nearest neighbor bonds;
identify a volatility for one or more of the plurality of bonds in the group of nearest neighbor bonds;
create a filtered group of nearest neighbor bonds by excluding those bonds with volatilities exceeding a predefined threshold;
calculate a correlation coefficient between pairs of the plurality of bonds within the filtered group of nearest neighbor bonds;
sort the filtered group of nearest neighbor bonds based on the correlation coefficient of the pairs of bonds;
select a predetermined number of bonds from the filtered group of nearest neighbor bonds to form an index group;
compute a weighted average index price for the index group; and
determine a variance for the predetermined number of bonds within the index group in relation to the weighted average index price.

12. The computer system of claim 11, wherein the k-nearest neighbor algorithm evaluates attributes including coupon, yield, ratings, maturity, sector, industry, and embedded options.

13. The computer system of claim 12, further configured to establish sensitivity settings for evaluating each attribute via the k-nearest neighbor algorithm.

14. The computer system of claim 11, further configured to identify volatility by calculating a standard deviation of bond sales prices over a predetermined time period.

15. The computer system of claim 14, further configured to receive bond sales prices from a third-party trade reporting and compliance engine.

16. The computer system of claim 11, wherein assessing volatility considers a beta of one or more of the plurality of bonds.

17. The computer system of claim 11, further configured to calculate correlation coefficients by determining a statistical association between bond sales prices over a specified period of time.

18. The computer system of claim 17, wherein the bond sales prices for calculating correlation are received from a third-party trade reporting and compliance engine and recorded in blockchain.

19. The computer system of claim 11, wherein computation of the weighted average index price considers the corresponding outstanding amount for each bond in the index group.

20. The computer system of claim 11, further configured to record the variance for each bond within the index group in relation to the weighted average index price in blockchain.
